(19) United States
(12) Patent Application Publication
(10) Pub. No.: US 2010/0332360 A1
(43) Pub. Date: Dec. 30, 2010

(54) RECONCILIATION OF ACCOUNTING DOCUMENTS

(75) Inventor: Dietmar Nowotny, Dielheim (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 12/495,380

(22) Filed: Jun. 30, 2009

(51) Int. Cl. G06Q 10/00

(52) U.S. Cl. 705/30

(57) ABSTRACT

The present disclosure involves reconciling subledger accounts by referencing source documents associated with business transactions. One process includes operations for receiving a request for reconciliation of a subledger account with its corresponding inventory and presenting at least one entry of the subledger account and at least one corresponding entry of an inventory. The inventory can be selected for reconciliation with the subledger account based on a shared subject matter of the subledger account and the inventory. If the difference between one of the entries of the subledger account and the corresponding entry of the inventory is a non-zero value, a request for reconciliation of the difference can be received. The process can further include identifying a source document associated with the entry of the subledger account and the corresponding entry of the inventory, generating a reconciliation report including a reference to the source document, and presenting the reconciliation report.

### TECHNICAL FIELD

The present disclosure relates to software, computer systems, and computer implemented methods for efficient reconciliation of accounting documents.

### BACKGROUND

Reconciliation of accounting documents is a major business task typically performed at the end of a business period (e.g., month, quarter, year) to ensure the validity and consistency of the general ledger, or main accounting record, of a business. Subledger accounts need to be reconciled or explained, especially at the end of a business period. For example, material stock, liabilities, receivabables and cash need to be reconciled with operational inventories. During reconciliation of accounting records, accounting entries are compared to other line items, such as operational inventories, for consistency.

The entries in a subledger account are generally comprised of items from source documents, which originate from business transactions. The information associated with the business transactions is documented in the source document, also known as a prima nota. In certain accounting software configurations, the information in the prima notas are then posted in entries in the subledger account. Current reconciliation of subledger accounts can be a challenging task that requires the comparison of multiple line items and the identification of numerous business objects or prima notas associated with the line items.

### SUMMARY

The present disclosure provides techniques for reconciling subledger accounts by referencing source documents associated with business transactions. A computer program product is encoded on a tangible medium, where the product comprises computer readable instructions for causing one or more processors to perform operations. These operations can include receiving a request for reconciliation of a subledger account and presenting at least one entry of the subledger account and at least one corresponding entry of the corresponding inventory. The inventory can be selected for reconciliation with the subledger accounts based on a shared subject matter of the subledger account and the inventory. If the difference between entries of the subledger account and the corresponding entry of the inventory is a non-zero value, a request for reconciliation of the difference can be received. The computer program product can further launch, implement, store, or otherwise execute operations such as identifying a source document associated with the entry of the subledger account and the corresponding entry of the inventory, generating a reconciliation report including a reference to the source document, and presenting the reconciliation report.

Various implementations can include the following features. For example, each source document may be assigned a reference number allowing easy referencing of the source document. During reconciliation of accounting, sources of inconsistency within the system may be identified and reconciled by identifying relevant source documents based on their reference numbers. The techniques can also include defining an inventory as a count of business processes associated with a particular subject matter. The inventory may be associated with a subledger account related to the same subject matter. When an inventory is reconciled with an associated accounting subledger, a high-level report listing any differences between corresponding entries of the inventory and the subledger account is generated. If corresponding entries have differences, a detailed, drill down report identifying the source documents causing the differences may be generated.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment implementing various features of accounting reconciliation within the context of the present disclosure;

FIGS. 2A-B are a flow diagram depicting computer implemented transaction processing for inventories and accounting within a particular implementation of the present disclosure;

FIG. 3 is a chart depicting example inventory and accounting categories for use by an appropriate system, such as the system described in FIG. 1;

FIG. 4 is a conceptual diagram depicting an example implementation of FIG. 3;

FIG. 5 is a flow chart of an example reconciliation method implemented using an appropriate system, such as the system described in FIG. 1;

FIG. 6 is an example screenshot of a reconciliation report for use by an appropriate system, such as the system described in FIG. 1;

FIG. 7 is an example screenshot of a drill down view of an accounts payable subledger account for use by an appropriate system, such as the system described in FIG. 1; and

FIG. 8 is an example screenshot of a drill down view of a payables inventory account for use by an appropriate system, such as the system described in FIG. 1.

### DETAILED DESCRIPTION

This disclosure generally describes computer systems, software, and computer implemented methods for reconciling accounting ledgers with inventories through referencing of unique source documents. In certain implementations, reconciliation of accounting ledgers comprises identifying sources of inconsistency within an accounting ledger by comparing details of one or more associated business transactions or processes. In the present disclosure, differences in accounting entries may be easily analyzed by directly referencing the source documents that are the cause of the differences in accounting. For example, in some implementations, business software used for performing accounting tasks generate primary (root or source) business objects, often called prima nota objects, that are associated with business processes. A prima nota can include images of original business documents such as, for example, actual customer invoices and payments. Each business transaction is often linked to a unique source document (prima nota). At least a portion of the data contained in the prima nota may then be stored in a subledger account. The subledger account provides the values of a prima nota for documentation within a ledger and also a unique link to the prima nota. When subledgers in accounting are reconciled, specific entries and transactions within the ledgers may be analyzed in detail by accessing and/or displaying, in a drill down format for example, detailed information associated with particular prima notas, including a unique reference number of the prima nota, that are referenced within the specific ledger entry.

One potential benefit of such techniques is that software implementing this technology has the capability to display detailed information concerning specific business transactions within a subledger account by linking to source documents associated with the business transactions, which allows easy reconciliation and analysis of differences within the ledger. Further, clear referencing between prima notas and other accounting documents allows for transparent document flow such that a client or other computer may follow up on processes consisting of multiple process steps. This may be beneficial when, for example, auditors seeking to locate unique source documents responsible for postings in an account can trace each business transaction to a unique prima nota.

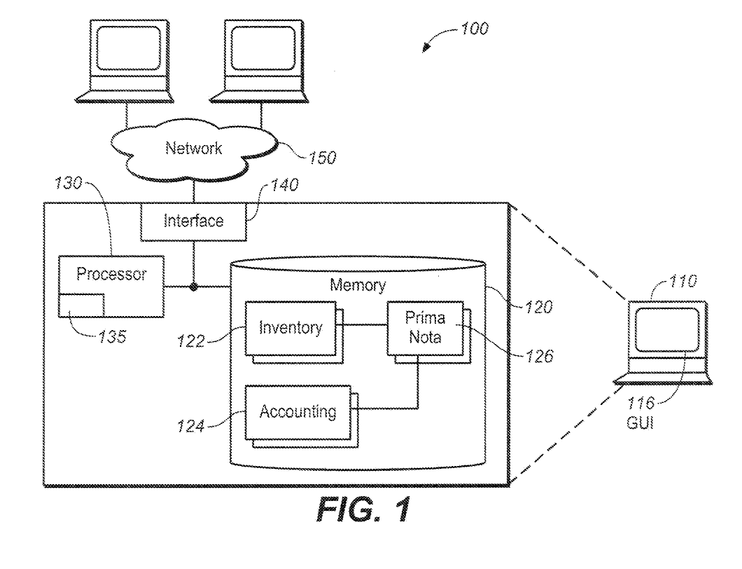

Turning to the illustrated example, FIG. 1 illustrates an example system 100 for reconciling accounting ledgers through referencing of unique prima notas 126. The system 100 may include any computer or processing device 110 such as, for example, a server, general-purpose personal computer (PC), Macintosh, workstation, Unix-based computer, touch screen terminal, network computer, kiosk, wireless data port, smart phone, personal data assistant (PDA), one or more processors within these or other devices, or any other suitable processing device. In other words, the present disclosure contemplates computers other than general purpose computers, as well as computers without conventional operating systems. Computer 110 may be adapted to execute any operating system including Windows, Linux, UNIX, Windows Server, or any other suitable operating system. According to one embodiment, computer 110 may also include or be communicably coupled with a web server and/or a mail server.

Illustrated computer 110 includes example processor 130. Although FIG. 1 illustrates a single processor 130 in computer 110, two or more processors may be used according to particular needs, desires, or particular embodiments of system 100. Each processor 130 may be a central processing unit (CPU), a blade, an application specific integrated circuit (ASIC), or a field-programmable gate array (FPGA). The processor 130 may execute instructions and manipulate data to perform the operations of system 100, often using software. For example, processor 130 may execute some or all of a business application 135. In some instances, a business application 135 may execute or provide a number of application services, including customer relationship management (CRM) systems, human resources management (FIRM) systems, financial management (FM) systems, project management (PM) systems, knowledge management (KM) systems, and electronic file and mail systems. The business application 135 may be operable to exchange data with a plurality of enterprise-based systems and, in the process, update or modify one or more content repositories. The various services performed may allow the business application to orchestrate one or more business processes in synchronization with other processes that directly or indirectly affect the information stored within one or more of the content repositories. For instance, the business application 135 may drive business processes across different applications, systems, technologies, and organizations, thus driving end-to-end business processes across heterogeneous systems or sub-systems. The business application 135 can be, for example, a pricing update, inventory interface, sales order processor, or any other business application. Regardless of the particular implementation, “software” may include any computer-readable instructions embodied on tangible medium (such as memory 120) including executable code, firmware, wired or programmed hardware, or any combination thereof as appropriate such that it is stored on tangible medium and operable to be executed. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The computer also typically includes a user interface, such as a graphical user interface (GUI) 116. The GUI 116 comprises a graphical user interface operable to, for example, allow the user of the client to interface with at least a portion of the platform for any suitable purpose, such as creating, preparing, requesting, or analyzing data, as well as viewing and accessing source documents associated with business transactions. Generally, the GUI 116 provides the particular user with an efficient and user-friendly presentation of business data provided by or communicated within the system. The GUI 116 may comprise a plurality of customizable frames or views having interactive fields, pull-down lists, and buttons operated by the user. The GUI 116 is often configurable, supports a combination of tables and graphs (bar, line, pie, status dials, etc.), and is able to build real-time portals, where tabs are delineated by key characteristics (e.g. site or micro-site). Therefore, the GUI 116 contemplates any suitable graphical user interface, such as a combination of a generic web browser, intelligent engine, and command line interface (CLI) that processes information in the platform and efficiently presents the results to the user visually. The server can accept data from the client via the web browser (e.g., Microsoft Internet Explorer or Mozilla Firefox) and return the appropriate HTML or XML responses to the underlying engine using a network.

The example client may be communicably coupled with a network 150 that facilitates wireless or wireline communication between the computer 110 and any other local or remote computer, such as clients. The network 150 may be all or a portion of an enterprise or secured network. In another example, the network 150 may be a virtual private network (VPN) merely between the server and the client across wireline or wireless link. Such an example wireless link may be via 802.11a, 802.11b, 802.11g, 802.11n, 802.20, WiMax, and many others. The network 150 may include one or more local area networks (LANs), radio access networks (RANs), metropolitan area networks (MANs), wide area networks (WANs), all or a portion of the global computer network known as the Internet, and/or any other communication platform or systems at one or more locations. The network 150, however, is not a required component of the present disclosure.

Computer 110 may also include interface 140 for communicating with other computer systems over network 150 in a client-server or other distributed environment. In certain embodiments, computer 110 receives requests for data access from local or remote senders through interface 140 for storage in memory 120 and/or processing by processor 130. Generally, interface 140 comprises logic encoded in software and/or hardware in a suitable combination and operable to communicate with network 150. More specifically, interface 140 may comprise software supporting one or more communications protocols associated with communications network 150 or hardware operable to communicate physical signals.

In general, the computer 110 is a computer with memory 120 for storing data and program instructions. Illustrated memory 120 represents any memory and may take the form of volatile or non-volatile memory including, without limitation, magnetic media, optical media, random access memory (RAM), read-only memory (ROM), removable media, or any other suitable local or remote memory components. Illustrated memory 120 includes storage of source documents or prima notas 126 as well as accounting data structures such as subledger accounts 124 and inventory 122. But memory 120 may also include any other appropriate data such as HTML files, data classes or object interfaces, unillustrated software applications or sub-systems, and so on.

The prima notas 126 in memory 120 are source documents of business transactions. Generally, “prima nota” is a business term meaning “original document” or “originating document”. For example, business transactions may be documented on a physical document, and prima notas 126 are data objects consisting of images of the physical business documents. Business transactions may also be associated with a business process consisting of many process steps (business transactions). Examples of prima notas 126 for financial operations may include (without limitation) Bank Statement, (Outgoing) Bank Transfer, Bank-to-Bank Transfer, Bank Payment Advice Payment Allocation, (Incoming) Advice, Incoming Credit Card Payment, Incoming Direct Debit, Bill of Exchange Deposits, (Outgoing) Check, Bill of Exchange Cashings, Sales and Use Tax Return, VAT Return on Sales and Purchases, Withholding Tax Return, Manual Tax Entry, Balance Confirmation, Due Payment, Due Clearing, Dunning, and Expense Report. The prima notas 126 may exist in unique states, such as in preparation, released, canceled, and archived. The archiving mechanisms of prima notas 126 allow access to the prima notas 126 and associated documents for a number of years even after deletion.

Each prima nota 126 also consists of a unique reference number. The reference number allows one prima nota 126 to link to another to form a document flow or chain. The reference numbers may also be used to link prima notas 126 to other documents or processes such as subledger accounts 124. In certain implementations, each prima nota 126 is linked to one or more subledger accounts 124. Accounting 124 may be represented in the form of a general ledger or a subledger account within the general ledger. The subledger account is a document providing monetary valuation or explanation of items in a general ledger and where the line items of the subledger are based on values associated with one or more prima notas 126. That is, the subledger accounts 124 may contain values originally found on the prima notas 126. In other words, accounting documents provide documentation of the values of a prima nota 126 in the form of a subledger or general ledger, for example. Subledger accounts 124 also include references to prima notas 126 using the reference numbers of the prima notas 126. Accordingly, prima notas 126 and subledger accounts 124 may be easily referenced, resulting in a streamlined business document flow and the capability to display the primary process associated with a line item in a ledger at any point in time. Other features of subledger accounts 124 may include archiving mechanisms allowing access to the documents for a number of years.

A prima nota 126 may also be linked to other sources such as operational inventories 122. An inventory 122 is an operational component that comprises a storage or list of variables associated with a particular group of business transactions or processes. In contrast to subledger accounts 124, inventories 122 do not provide monetary valuations of accounting items. Rather, inventories 122 track accounting items on a component basis, providing a count of components associated with the inventory. Inventory categories may include Material, Payables, Receivables, Tax, or Cash. For example, all receivables may be tracked in a Receivables Inventory. Transactions resulting in an account receivable, such as the creation and sending of a customer invoice to a customer, result in an update of the Receivables Inventory. Such updates may be caused by messages that are received by the inventory object, where a tracking of accounts receivable is incremented or decremented accordingly.

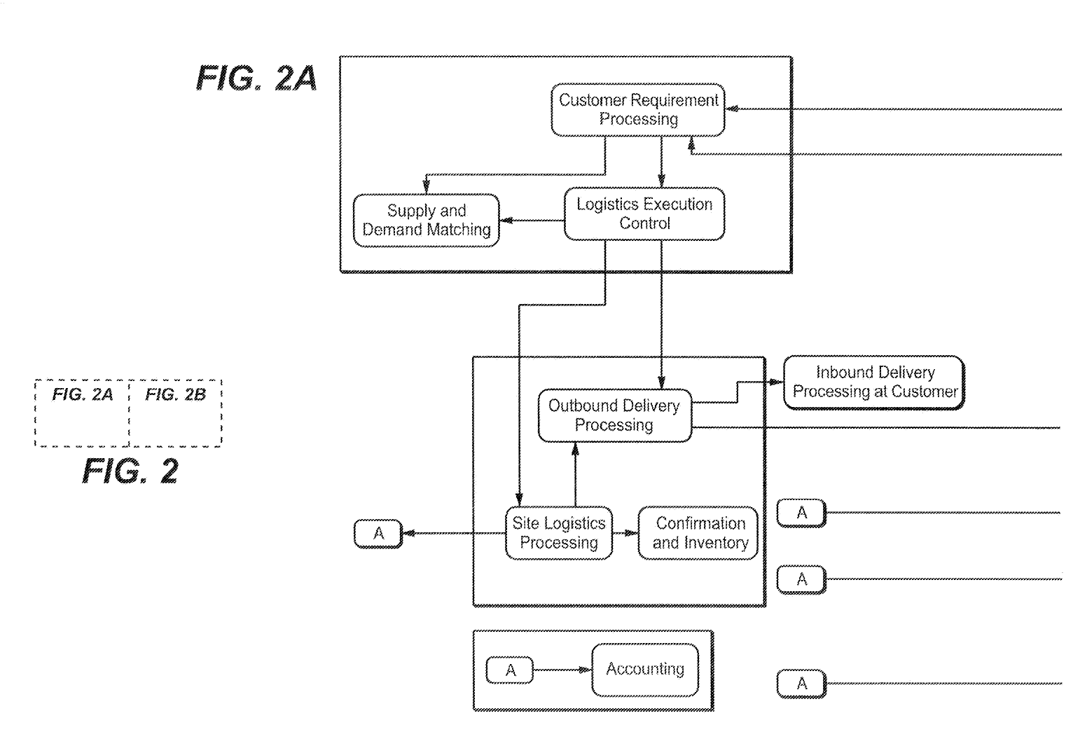

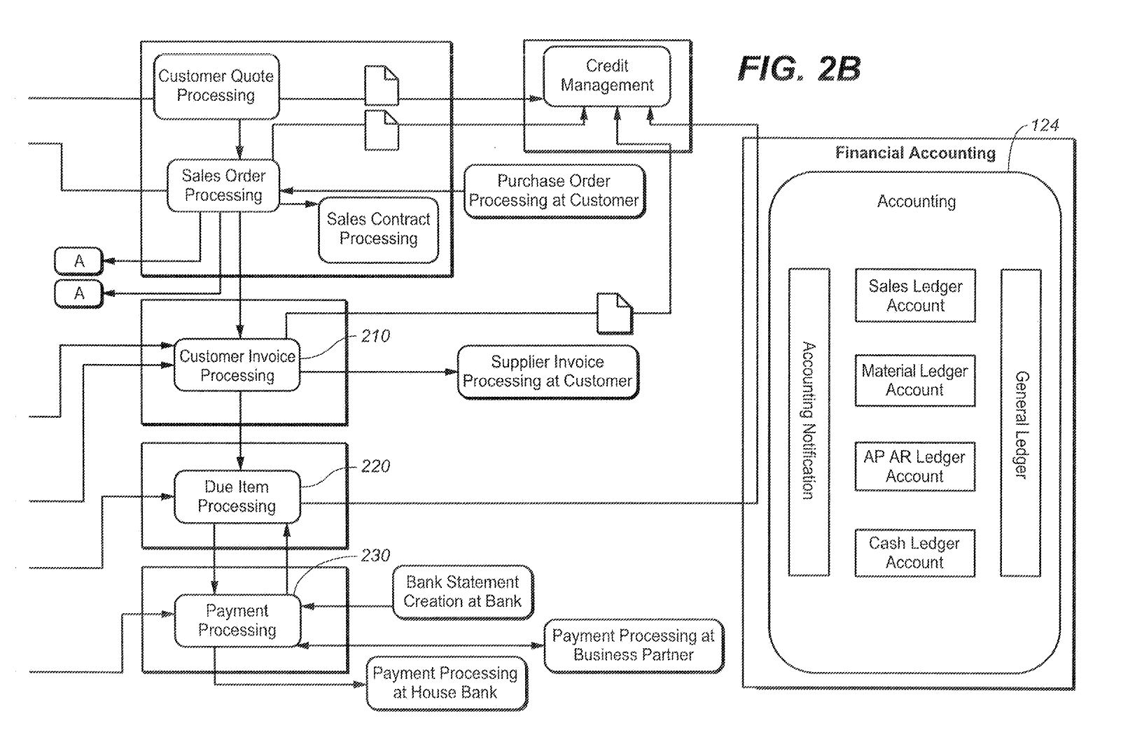

FIG. 2 is a flow diagram depicting transaction processing for inventories and accounting. A customer invoice processing unit 210 processes all invoices resulting in a receivable and manages the prima notas 126 for the invoices. Similarly, a payment processing unit 230 manages accounts payable and associated prima notas 126. The inventory for all due items, whether accounts receivable or accounts payable, is maintained at a due item processing unit 220. The due item processing unit 220 manages the collection, administration, and monitoring of receivables or payables from deliveries or services such as from customer invoice processing 210 or payment processing 230. Thus, business transactions processed in customer invoice processing 210 or payment processing 230 and that are related to accounts receivable and accounts payable are tracked in a due item inventory. The business transactions are also posted in a subledger account 124 such as an accounts payable or accounts receivable subledger account. At a certain point, the entries related to payables and/or receivables subledger accounts which comprise payables or receivables items, may be reconciled with the due item inventory in due item processing 220.

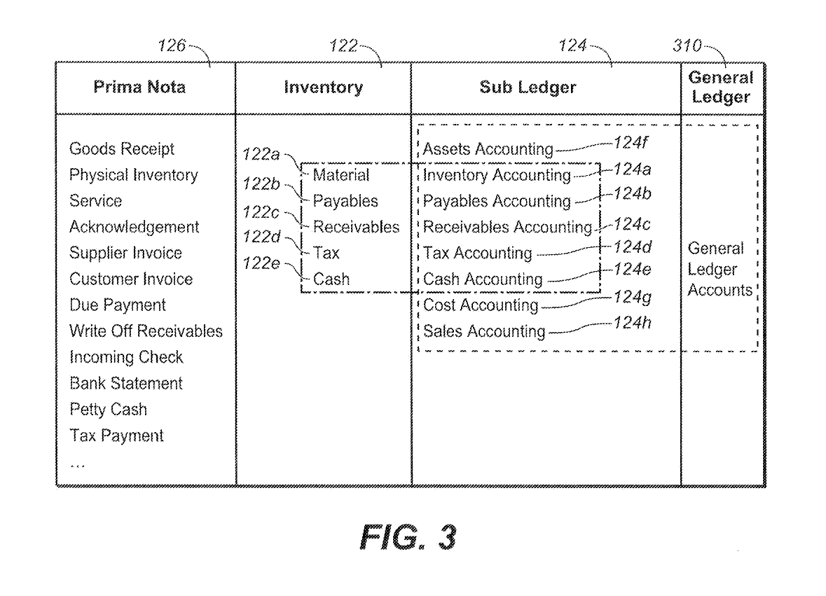

As depicted in FIG. 3, each inventory category is comprised of prima notas 126 that are associated with that particular inventory 122. In some implementations, each inventory category may also be associated with a particular subledger account 124. The association of the inventory category with the subledger account may be based on a shared business categorization, subject matter, or other criteria. For example, as illustrated in FIG. 3, Material Inventory 122a is associated with Inventory Accounting 124a, Payables Inventory 122b is associated with Payables Accounting124b, Receivables Inventory 122c is associated with Receivables Accounting124c, Tax Inventory 122d is associated with Tax Accounting 124d, and Cash Inventory 122e is associated with Cash Accounting 124e. Each subledger account 124 is reconciled with its corresponding inventory 122. In the illustrated implementation, however, certain subledger accounts such as Assets Accounting 124f, Cost Accounting 124g, and Sales Accounting 124h are not associated with a corresponding inventory 122.

The reconciliation of subledger accounts 124 involves identifying inconsistent entries in the subledger account 124 and determining the cause of the inconsistencies. During reconciliation, corresponding data objects are compared to determine sources of consistency. The comparison can be accomplished on three different levels. In object-to-object reconciliation, each operational document, or prima nota 126, is reconciled with one or more associated subledger account 124. For example, in object-to-object reconciliation, when an invoice is created, the invoice's prima nota can be compared or reconciled with a corresponding subledger account such as Receivables Accounting 124c, resulting in a precise but painstaking accounting reconciliation.

Subledger accounts 124 may also be reconciled at the inventory level. Rather than reconciling subledger accounts 124 with each prima nota 126 associated with that particular subledger account 124 as implemented in object-to-object reconciliation, subledger accounts 124 may be reconciled with their respective operational inventories 122. As such, items within an operational inventory (e.g., Material, Receivables, Payables, Tax, Payment) can be compared to items within an associated subledger account (e.g., Inventory, Receivables, Payables, Tax, Payment). As seen in example FIG. 3, Material Inventory 122a is reconciled with Inventory Accounting 124a, Payables Inventory 122b is reconciled with Payables Accounting 124b, and so on. The reconciliation of operational inventories 122 with their corresponding subledger accounts 124 may be more efficient when compared to object-to-object reconciliation, primarily because fewer items need to be compared against the subledger accounts 124 given that the prima notas 126 are already compiled into inventories 122 when the subledger accounts 124 are reconciled with the inventories 122.

In another example, subledger accounts 124 may also be reconciled with general ledger accounts 310. Often, however, subledger accounts 124 can be inherently consistent with their general ledger accounts 310 because balances within the subledger accounts 124 and general ledger accounts 310 rely on the same documents. Put differently, subledger accounts 124 explain the general ledger 310 by providing valuation of items associated with the general ledger 310. For example, a receivables account in the general ledger may be described in detail by a subledger account; the subledger account may list the various components of the general receivables account according to business partner or other criteria. As depicted in FIG. 3, the listed subledger accounts 124—Assets Accounting 124f, Inventory Accounting 124a, Payables Accounting 124b, Receivables Accounting 124c, Tax Accounting 124d, Cash Accounting 124e, Cost Accounting 124g, and Sales Accounting 124h—are associated with a general ledger 310.

Thus, because object-to-object reconciliation is typically the most time-consuming and painstaking level of reconciliation, and because subledger 124 and general ledger 210 reconciliation can be inherently consistent, reconciliation of subledger accounts 124 with inventory 122 is often the primary or first level of reconciliation performed. In one embodiment, as described below, reconciliation at the inventory level is performed first. If an inconsistency in accounting is identified at the inventory level, object-to-object reconciliation may be performed to identify specific transactions or data objects that have caused the inconsistency.

The reconciliation of subledger accounts with inventory also requires selection of the appropriate data objects that should be reconciled. In other words, business transactions associated with a subledger account 124 should generally only be reconciled with business transactions associated with inventory 122 that are related in some manner to the business transactions on the accounting side. In one embodiment, items that are reconciled with one another should share three common attributes—time, measurement of quantity, and object business attribute. First, the time frame attributed to the subledger account 124 and inventory 122 should be the same; that is, if a particular inventory 122 and its corresponding subledger account 124 are to be compared, they should share the same transaction date, or key date, in order to cover the same business transactions accounted for at the designated key date. In some embodiments, a specific transaction date is used for the key date as opposed to a time window, time period, or time frame. The key date on which a particular reconciliation step will be made should be the same for both inventory 122 and accounting 124. Business transactions related to either inventory 122 or the subledger account 124 that occur after the key date generally are not included in the particular reconciliation process.

Second, the items in the subledger accounts 124 and inventory 122 should share the same measurement of quantity or amount. In other words, comparing balances in a subledger account with balances in inventory is only appropriate when the balances share the same unit of measurement. For example, when comparing services rendered, items in the subledger account 124 and inventory 122 should have the same measurement of the time spent performing the services, such as hours or days. Alternatively, when comparing transactions involving invoices in inventory 122 to transactions involving invoices in accounting 124, the same monetary unit or currency (e.g., dollars, euros) may be selected to measure the values of the invoices in inventory 122 and in accounting 124.

Finally, the inventory 122 and subledger accounts 124 items to be reconciled should share at least one common object business attribute. For example, a data object representing at least part of a business transaction may hold a plurality of business attributes such as a particular company, vendor, business partner, country, cash location, tax authority, tax event, etc. associated with the transaction. In certain implementations, other data objects also share one or more of the same business attributes. Accordingly, during reconciliation, an item in a subledger account 124 is reconciled with an item in inventory 122 that possesses at least one of the same business attributes held by the item in the subledger account 124. For example, to reconcile an item or data object in a subledger account 124 with the corresponding inventory 122 data object concerning the amount of cash held by a particular company and stored in a particular location, the data objects that are to be reconciled on both sides (inventory and accounting) should possess business attributes of: (1) cash owned by the particular company and (2) the particular location where the cash is stored. Other examples of particular attributes commonly associated with particular inventories may include Tax Authority or Tax Event for Tax Inventories 122d, Country or Business Partner for Receivables 122c and Payables Inventories 122b, or Lot for Material Inventories 122a.

The three shared attributes—time, measurement of quantity, and object business attribute—should be specified before reconciliation to allow corresponding data objects to be reconciled in their proper context. Thus, for example, items associated with transactions that are related to a certain company and conducted in a certain currency at a certain time should generally be reconciled with other items associated with transactions that are related to the same company and conducted in the same currency within the same measure of time.

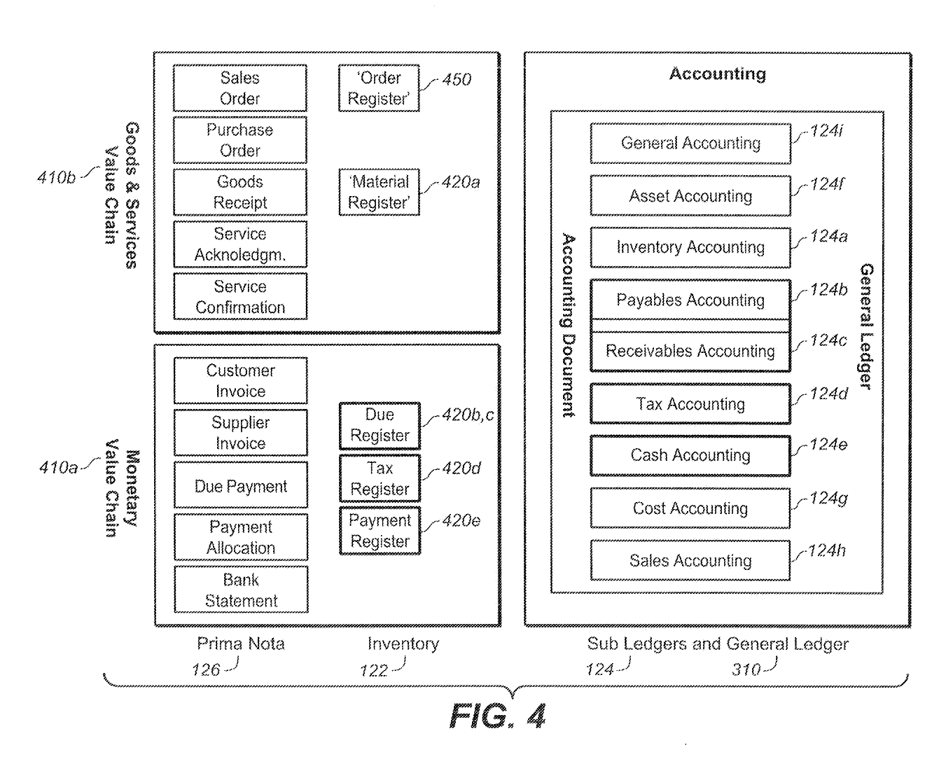

During reconciliation of subledger accounts 124 at the inventory level, entries in a subledger account 124 are compared to items in inventory 122, and inconsistent entries are identified. Inventories can be implemented as registers 420 as depicted in FIG. 4. A Payment Register 420e includes cash and payment related items, a Tax Register 420d includes receivables and payables from tax, a Due Register 420bc includes receivables and payables from goods and services, and so on. Certain registers 420 such as the Due Register 420bc, Tax Register 420d, and Payment Register 420e are grouped together based on a business categorization such as, for example, Monetary Value Chain 410a in the illustrated example. Each register 420 is also associated with particular prima notas 126, such as Customer Invoice, Supplier Invoice, Due Payment, Payment Allocation, and Bank Statement. Likewise, the Order Register 450 and Material Register 420a may be grouped and included in a Goods and Services Value Chain categorization 410b.

Accounting comprises a general ledger 310 and subledger accounts 124 that explain in further detail the accounts in the general ledger 310. As seen in FIG. 4, example subledger accounts may include General Accounting 124i, Asset Accounting 124f, Inventory Accounting 124a, Payables Accounting 124b, Receivables Accounting 124c, Tax Accounting 124d, Cash Accounting 124e, Cost Accounting 124g, and Sales Accounting 124h. Several subledger accounts are each associated with particular inventories (registers). For example, Cash Accounting 124e is associated with the Payment Register 420e, Tax Accounting 124d is associated with the Tax Register 420d, Payables 124b and Receivables Accounting 124c are both associated with the Due Register 420bc, and Inventory Accounting 124a is associated with the Material Register 420a. During reconciliation of subledger accounts 124 with inventory 122, the associated registers 420 and subledger accounts 124 are compared to one another to identify inconsistent entries.

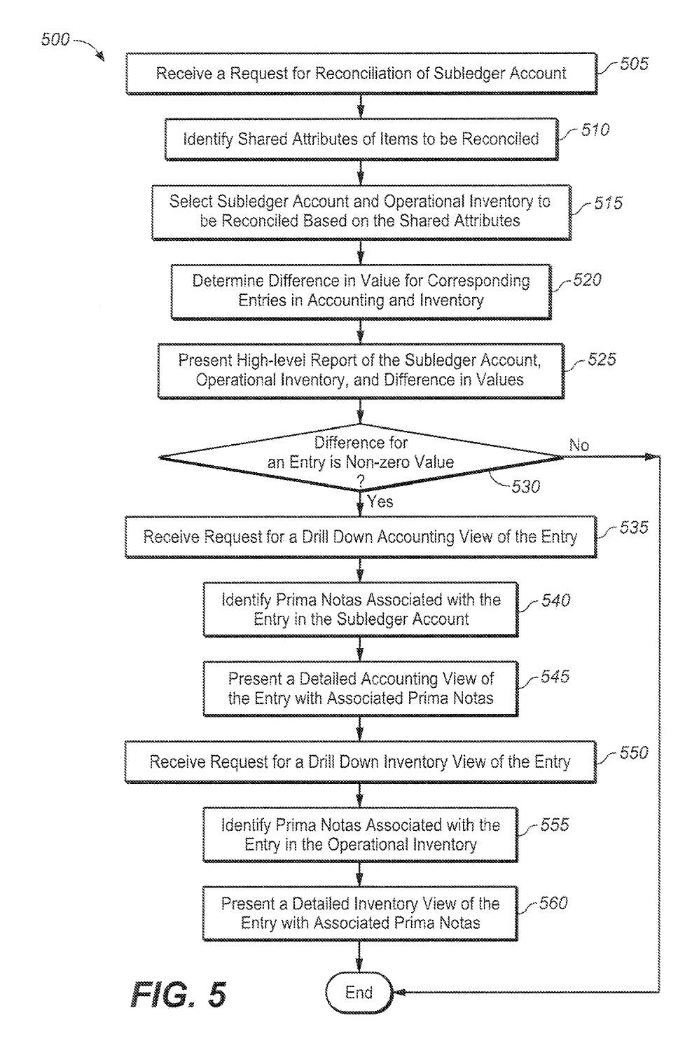

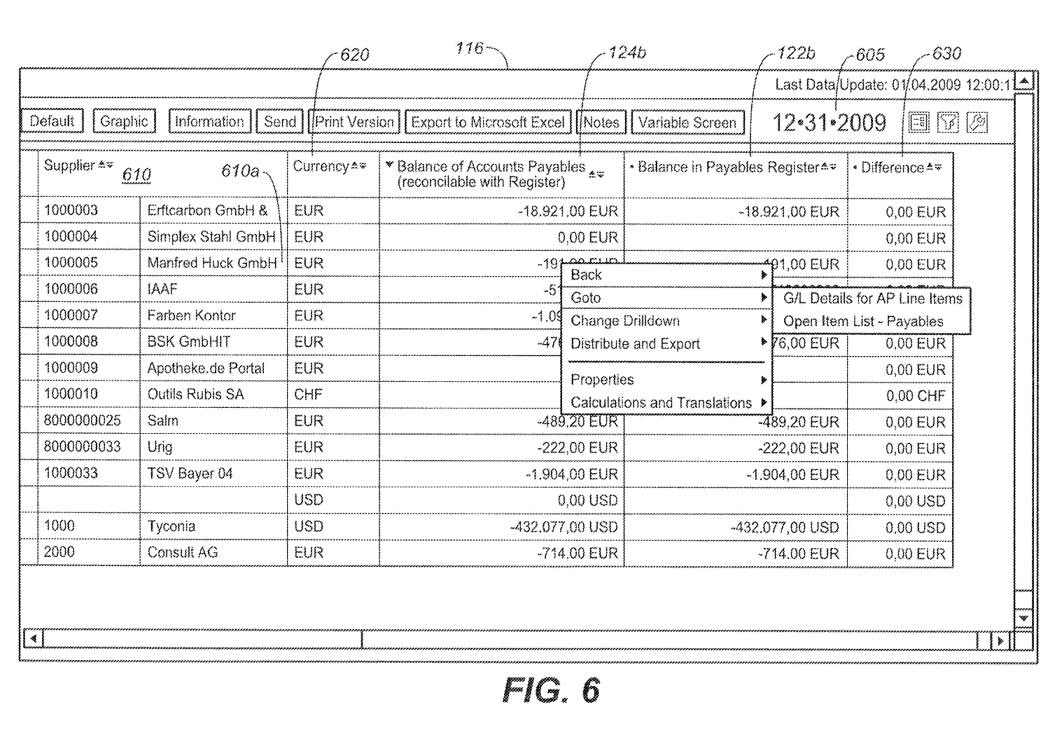

FIG. 5 is a flow chart 500 depicting an example computer implemented reconciliation process of the present disclosure. First, a request for reconciliation of a subledger account is received at step 505. In the present example, the subledger account is to be reconciled at the inventory level; that is, entries in a subledger account 124 are compared to items in inventory 122. After the request for reconciliation is received, the shared attributes of the items to be reconciled are identified at step 510. Here, the shared attributes may be selected manually by a user or automatically determined. Based on the identified shared attributes, the appropriate subledger account and operational inventory are selected for reconciliation at step 515. Each of the corresponding entries in the subledger account and operational inventory are compared and the difference in value between the corresponding entries is determined at step 520. As illustrated in example FIG. 6, a high-level report of the entries of the subledger account and operational inventory as well as differences between corresponding accounting and inventory entries can be generated and presented at step 525.

FIG. 6 depicts a visual representation of reconciliation performed on a computer. In the illustrated example, a report of subledger accounts payable is displayed in the GUI 116 for reconciliation with its corresponding inventory payables register. Generally, there is one report per subledger account and inventory; here, a report comparing items in the Payables Inventory 122b (Payables Register) and items in the corresponding subledger account (Accounts Payable 124b) is generated. Items in the Payables Register 122b occupy a column while items in Accounts Payable 124b occupy a separate column. The displayed report in the GUI 116 indicates that the three common attributes described above—key date, measurement of quantity, and object business attribute—are applied to ensure that the appropriate accounting and inventory items are reconciled. First, all items shown in the report share a common key date 605, indicating that as of the key date 605, the balance in both Accounts Payable 124b and the Payables Register 122b include the displayed items. Second, for each line item, the values displayed under Accounts Payable 124b and under the Payables Register 122b both are represented using the same measurement of quantity. In the example shown in FIG. 6, a report is generated for reconciliation of accounts payable, so each line item represents the monetary value of the balance in a particular account under both Accounts Payable 124b and the Payables Register 122b. The monetary value is expressed in a particular currency as listed in the currency column 620, whether in euros, U.S. dollars, or other currency, and the values for a particular line item under Accounts Payable 124b and the Payables Register 122b are displayed in the same currency for proper reconciliation. Finally, the data objects that are compared to one another share at least one common business attribute. Here, balances of Accounts Payable 124b are compared with balances in the Payables Register 122b for each supplier 610, so items under Accounts Payable 124b are only compared to corresponding items under the Payables Register 122b that share the same supplier 610.

In some implementations, other features of a report generated for reconciliation may include a column indicating any difference in balance under the subledger account 124b and the inventory account 122b. The differences column 630, like the other columns, is capable of being sorted in ascending or descending order such that unreconciled line items can be more easily displayed and focused on. Further, different colors (such as red and blue) may be used in addition to a negative or positive sign to further indicate a non-zero balance in a particular column (subledger or inventory account) relative to its corresponding column (inventory or subledger account). If the difference column 630 indicates a difference between the subledger 124b and inventory 122b account, the difference can be reconciled by identifying the source of the inconsistency. In certain embodiments, the identification is accomplished by allowing a detailed report in the form of a drill down display to be presented to the user when the user selects an option to view a particular line item in more detail.

Returning to FIG. 5, if there is a non-zero difference between the subledger account and inventory for a particular entry, a request for a drill down accounting view of the entry is received at steps 530 and 535. The prima notas 126 associated with the particular subledger account entry are identified at step 540 and referenced based on the prima nota's unique reference number. Once the prima notas 126 are identified, a detailed drill down view of the subledger account entry is presented at step 545. A request can also be received for a drill down inventory view of the entry at step 550. For the request for a drill down inventory view, the prima notas associated with the operational inventory entry are identified based on reference number at step 555, and a detailed drill down view of the operational inventory is presented at step 560.

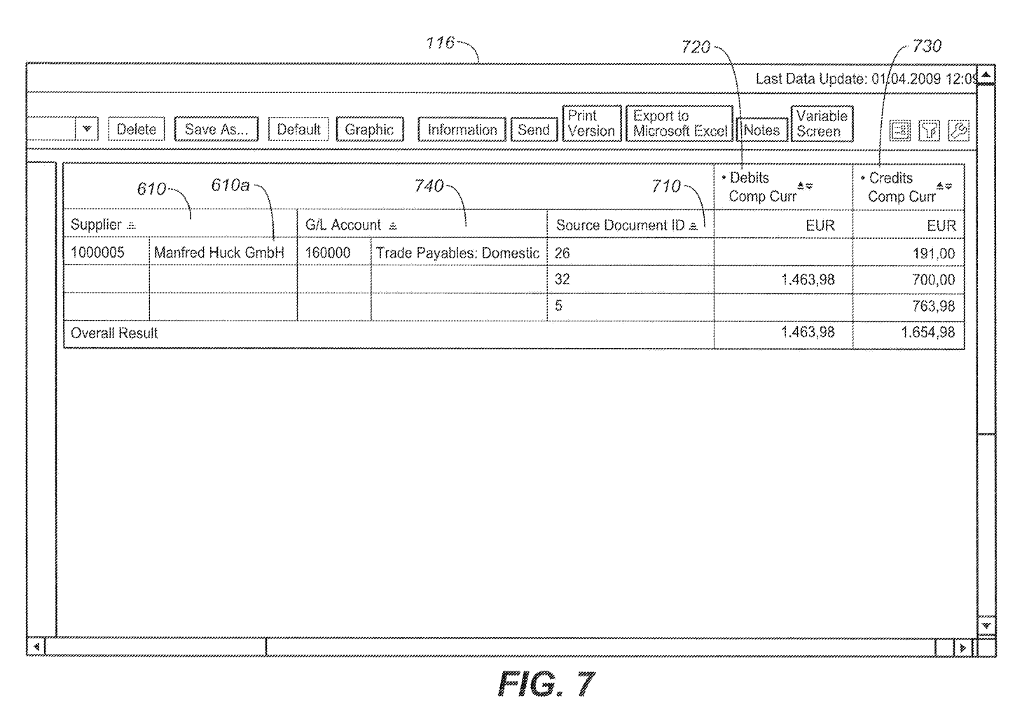

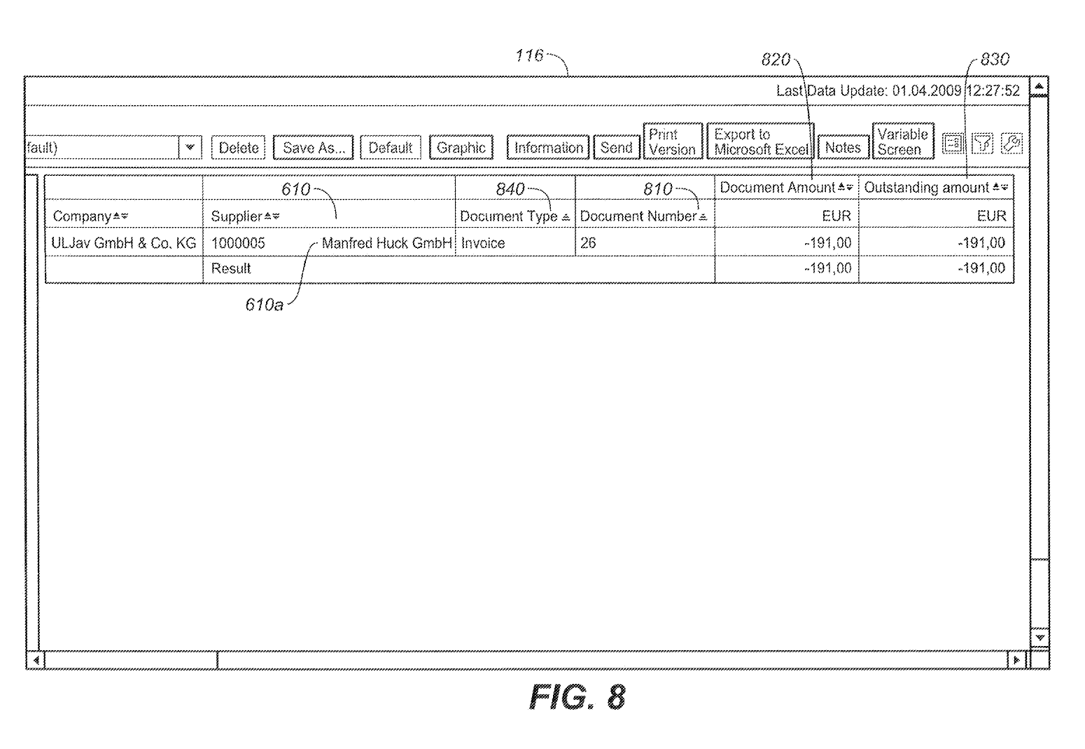

In the illustrated example of FIG. 6, a user may learn that a deficit exists in the balance for supplier Manfred Huck GmbH 610a in the Payables Register 122b relative to Accounts Payable 124b. The user may discover the deficit either from the difference column 630 or from visually comparing the balances in the Accounts Payable 124b and Payables Register 122b columns. The interface presents the option of accessing a detailed report of either the balance in the Accounts Payable column 124b, as illustrated in FIG. 7, or the balance in the Payables Register 122b, as illustrated in FIG. 8, for supplier Manfred Huck GmbH 510a in order to further reconcile the difference in balances for the account. In other words, the accounts can be reconciled when the user identifies from the detailed report(s) one or more specific transactions associated with the particular account that has led to the difference in balances for this particular supplier 610a.

FIG. 7 depicts a screenshot of the drill down view comprising a detailed report of the payables subledger account 124b for supplier Manfred Huck GmbH 610a in the illustrated example. The detailed report provides a break down of the components comprising the balance of the Accounts Payable subledger account 124b. In particular, the detailed report specifies the transactions associated with the Accounts Payable 124b for this particular supplier 610a and the prima notas 126 associated with those transactions. The prima notas 126 are referenced according to a reference number or Source Document ID number 710. Other details related to each transaction may also be displayed, such as the transactional values 720 and 730 for each transaction and the general ledger account number 740. Using the detailed report similar to one depicted in FIG. 7, the user may identify the transactions that have been posted toward the subledger account 124b as well as link to the specific prima notas 126 associated with the transactions based on the unique reference numbers 710 for the prima notas 126. The unique reference number of a prima nota allows for quick reference to the prima nota 126 and fast error analysis during reconciliation.

In FIG. 8, a screenshot of the drill down view of the corresponding payables inventory item 122b for example supplier Manfred Huck GmbH 610a is shown. As with the drill down view of the subledger account, in the detailed inventory report, details relating to the transactions associated with the inventory account 122b are displayed, including any prima notas 126 associated with the transactions, document or prima nota type 840 and the reference number 810 of the prima notas 126, and other transactional values 820 and 830 associated with the prima notas 126. Again, information concerning the prima notas 126 is accessible based on the unique reference number 810 of each prima nota 126.

As seen in FIGS. 7 and 8, the drill down views help explain any differences in the balances of the subledger accounts 124b and inventories 122b by displaying specific transactions associated with specific line items in the general reconciliation report depicted in FIG. 6. At the level of detail displayed in the drill down views, object-to-object reconciliation may be performed. That is, specific prima notas can be reconciled with subledger accounts by tracing any inconsistent balances within a subledger account to the specific prima notas that may be the source of the inconsistencies.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method for causing a processor to generate an accounting reconciliation report, the method comprising:
receiving a request for reconciliation of a subledger account with a corresponding inventory;
presenting at least one entry of the subledger account and at least one corresponding entry of an inventory, wherein the inventory is selected with the subledger account based on shared subject matter between the subledger account and the inventory;
if a difference between one of the entries of the subledger account and the corresponding entry of the inventory is a non-zero value, receiving a request for reconciliation of the difference;
identifying a source document associated with the entry of the subledger account and the corresponding entry of the inventory;
generating a reconciliation report including a reference to the source document; and
presenting the reconciliation report.

2. The method of claim 1, wherein the reconciliation report is associated with the entry of the subledger account.

3. The method of claim 1, wherein the reconciliation report is associated with the entry of the inventory.

4. The method of claim 1, wherein an entry of the inventory is identified as a corresponding entry with respect to the entry of the subledger account based on an attribute shared with the entry of the subledger account.

5. The method of claim 4, wherein the shared attribute comprises one of a particular business attribute, key date, and unit of measurement.

6. The method of claim 1, wherein the inventory comprises a count of business processes associated with the shared subject matter and wherein the shared subject matter is one of materials, payables, receivables, tax, and cash.

7. The method of claim 1, wherein the source document comprises original data of a business process.

8. The method of claim 1, wherein the source document is identified based on an identification number of the source document.

9. The method of claim 8, wherein the reference to the source document includes the identification number of the source document.

10. The method of claim 1, further comprising:
automatically determining the difference between the entry of the subledger account and the corresponding entry of the inventory; and
presenting the difference in an identifiable fashion.

11. A computer program product encoded on a tangible medium, the product comprising computer readable instructions for causing one or more processors to perform operations comprising:
receiving a request for reconciliation of a subledger account;
presenting at least one entry of the subledger account and at least one corresponding entry of an inventory, wherein the inventory is selected with the subledger account based on shared subject matter between the subledger account and the inventory;
if a difference between one of the entries of the subledger account and the corresponding entry of the inventory is a non-zero value, receiving a request for reconciliation of the difference;
identifying a source document associated with the entry of the subledger account and the corresponding entry of the inventory; and
generating a reconciliation report including a reference to the source document.

12. The computer program product of claim 11, wherein the reconciliation report is associated with the entry of the subledger account.

13. The computer program product of claim 11, wherein the reconciliation report is associated with the entry of the inventory.

14. The computer program product of claim 11, wherein the entry of the subledger account and the corresponding entry of the inventory are associated with a particular business attribute.

15. The computer program product of claim 11, wherein the entry of the subledger account and the entry of the inventory comprise data from one or more source documents selected at a particular time.

16. The computer program product of claim 11, wherein the entry of the subledger account and the entry of the inventory comprise data of a particular unit of measurement.

17. The computer program product of claim 11, wherein the inventory comprises a count of business processes associated with the shared subject matter, wherein the shared subject matter is one of materials, payables, receivables, tax, and cash.

18. The computer program product of claim 11, wherein the source document comprises original data of a business process.

19. The computer program product of claim 11, wherein the source document is identified based on an identification number of the source document.

20. The computer program product of claim 19, wherein the reference to the source document includes the identification number of the source document.

21. The computer program product of claim 11, the operations further comprising:
automatically determining the difference between the entry of the subledger account and the corresponding entry of the inventory; and
presenting the difference.
